(19) United States
(12) Patent Application Publication
(10) Pub. No.: US 2026/0230776 A1
(43) Pub. Date: Aug. 6, 2026

(54) DATA TRANSMISSION METHOD, FIRST TERMINAL DEVICE, AND SECOND TERMINAL DEVICE

(71) Applicant: GUANGDONG OPPO MOBILE TELECOMMUNICATIONS CORP., LTD., Dongguan, Guangdong (CN)

(72) Inventors: Yali GUO, Dongguan, Guangdong (CN); Fei LU, Dongguan, Guangdong (CN)

(21) Appl. No.: 19/153,046

(22) PCT Filed: Nov. 23, 2021
(86) PCT No.: PCT/CN2021/132498

§ 371 Date: Aug. 1, 2025

(51) Int. Cl. H04W 4/06; H04W 8/00; H04W 28/02

(52) U.S. Cl. CPC H04W 4/06; H04W 8/005; H04W 28/0268

(57) ABSTRACT

The disclosure relates to a data transmission method, a first terminal device, and a second terminal device. The method includes the following. A second terminal device receives data transmitted by a first terminal device in a broadcast and/or multicast mode, and determines whether to relay the data in the broadcast and/or multicast mode by matching the data with first identification information.

### CROSS REFERENCE TO RELATED APPLICATION(S)

This application is a U.S. National Stage entry of International Application No. PCT/CN2021/132498, filed Nov. 23, 2021, which is incorporated herein by reference in its entirety.

### TECHNICAL FIELD

The disclosure relates to the field of communications, and more specifically, to a data transmission method, a first terminal device, and a second terminal device.

### BACKGROUND

Generally, short-range communication in broadcast/multicast mode only supports direct communication between two terminal devices with proximity based service (ProSe) capability. That is, the broadcast/multicast terminal device and the monitoring terminal device need to be close. If the monitoring terminal device is far away from the broadcast/multicast terminal device, the monitoring terminal device cannot monitor broadcast/multicast information.

### SUMMARY

Embodiments of the disclosure provide a data transmission method. The method includes the following. A second terminal device receives data transmitted by a first terminal device in a broadcast and/or multicast mode, and determines whether to relay the data in the broadcast and/or multicast mode by matching the data with first identification information.

Embodiments of the disclosure further provide a second terminal device. The second terminal device includes: a transceiver, a memory configured to store computer programs, and a processor configured to invoke and execute the computer programs stored in the memory to cause the second terminal device to: receive data transmitted by a first terminal device in a broadcast and/or multicast mode, and determine whether to relay the data in the broadcast and/or multicast mode by matching the data with first identification information.

Embodiments of the disclosure further provide a first terminal device. The first terminal device includes: a transceiver, a memory configured to store computer programs, and a processor configured to invoke and execute the computer programs stored in the memory to cause the first terminal device to: transmit data in a broadcast and/or multicast mode, where the data is used for a second terminal device receiving the data to determine whether to relay the data in the broadcast and/or multicast mode by matching the data with first identification information.

### BRIEF DESCRIPTION OF THE DRAWINGS

FIG. 1 is a schematic diagram of a communication system architecture according to embodiments of the disclosure.

FIG. 2 is a schematic diagram of a 5G system architecture according to embodiments of the disclosure.

FIG. 3 is a schematic diagram of a ProSe service in broadcast mode in embodiments of the disclosure.

FIG. 4 is a schematic diagram of service interaction via a relay UE in embodiments of the disclosure.

FIG. 5 is a schematic flowchart of a data transmission method provided in an embodiment of the disclosure.

FIG. 6 is a schematic flowchart of a data transmission method provided in another embodiment of the disclosure.

FIG. 7 is an interactive flowchart of a data transmission method of example 1 of the disclosure.

FIG. 8 is an interactive flowchart of an implementation of relay discovery of example 2 of the disclosure.

FIG. 9 is an interactive flowchart of another implementation of relay discovery of example 2 of the disclosure.

FIG. 10 is an interactive flowchart of a data transmission method of example 2 of the disclosure.

FIG. 11 is an interactive flowchart of a data transmission method of example 3 of the disclosure.

FIG. 12 is a schematic block diagram of a second terminal device according to an embodiment of the disclosure.

FIG. 13 is a schematic block diagram of a second terminal device according to another embodiment of the disclosure.

FIG. 14 is a schematic block diagram of a first terminal device according to an embodiment of the disclosure.

FIG. 15 is a schematic block diagram of a first terminal device according to another embodiment of the disclosure.

FIG. 16 is a schematic block diagram of a communication device according to embodiments of the disclosure.

FIG. 17 is a schematic block diagram of a chip according to embodiments of the disclosure.

FIG. 18 is a schematic block diagram of a communication system according to embodiments of the disclosure.

### DETAILED DESCRIPTION

The following will describe technical solutions of embodiments of the disclosure with reference to the accompanying drawings.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS) system, a long term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area networks (WLAN), a wireless fidelity (Wi-Fi), a 5th-generation (5G) system, or other communication systems.

Generally speaking, a conventional communication system generally supports a limited number of connections and therefore is easy to implement. However, with development of communication technology, a mobile communication system will not only support conventional communication but also support, for example, device to device (D2D) communication, machine to machine (M2M) communication, machine type communication (MTC), and vehicle to vehicle (V2V) communication, or vehicle to everything (V2X) communication. Embodiments of the disclosure can also be applied to these communication systems.

Optionally, a communication system in embodiments of the disclosure may be applied to a carrier aggregation (CA) scenario, a dual connectivity (DC) scenario, or a standalone (SA) network deployment scenario.

Embodiments of the disclosure have been described in connection with the network device and the terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device.

The terminal device may be a station (ST) in a WLAN, a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, and a next-generation communication system, for example, a terminal device in an NR network, a terminal device in a future evolved public land mobile network (PLMN), etc.

In embodiments of the disclosure, the terminal device may be deployed on land, for example, deployed indoors or outdoors, and may be handheld, wearable, or vehicle-mounted. The terminal device may also be deployed on water, for example, on a ship, etc. The terminal device may also be deployed in the air, for example, on an airplane, an air balloon, a satellite, etc.

In embodiments of the disclosure, the terminal device may be a mobile phone, a pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, etc.

By way of explanation rather than limitation, in embodiments of the disclosure, the terminal device may also be a wearable device. The wearable device may also be called a wearable smart device, which is a generic term of wearable devices obtained through intelligentization designing and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device, for example, an access network device, and the network device may be an access point (AP) in the WLAN, a base transceiver station (BTS) in the GSM or CDMA, may also be a Node B (NB) in WCDMA, and may further be an evolutional Node B (eNB or eNodeB) in LTE, or a relay station or AP, or an in-vehicle device, a wearable device, a network device or a g-Node B (gNB) in the NR network, a network device in the future evolved PLMN, etc.

Alternatively, the network device may be a core network device, such as a mobility management entity (MME), an access and mobility management function (AMF), or other network entities, which is not limited in embodiments of the disclosure.

By way of explanation rather than limitation, in embodiments of the disclosure, the network device may be of mobility. For example, the network device may be a mobile device.

Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station located on land, water, etc.

In embodiments of the disclosure, the network device can provide services for a cell, and the terminal device communicates with the network device through a transmission resource (for example, a frequency-domain resource or a spectrum resource) for the cell. The cell may be a cell corresponding to the network device (for example, a base station). The cell may correspond to a macro base station, and may correspond to a base station corresponding to a small cell. The small cell may include: a metro cell, a micro cell, a pico cell, a femto cell, and the like. These small cells are characterized by small coverage and low transmission power and are adapted to provide data transmission service with high-rate.

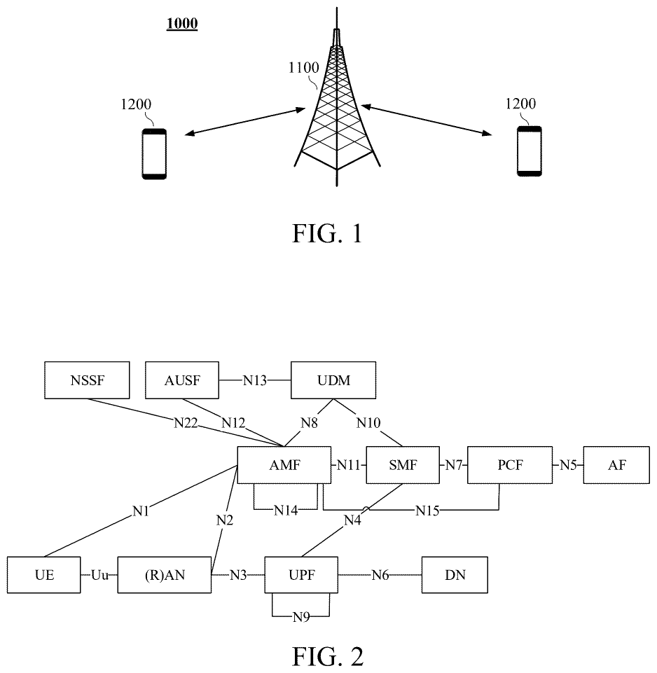

FIG. 1 schematically illustrates a wireless access system 1000 including one network device 1100 and two terminal devices 1200. Optionally, a wireless communication system 1000 may include multiple network devices 1100, and there may be other numbers of terminal devices in the coverage of each network device 1100.

It should be understood that, in embodiments of the disclosure, a device with communication functions in a network/system can be referred to as a “communication device”. Taking the communication system illustrated in FIG. 1 as an example, the communication device may include the network device and the terminal device that have communication functions. The network device and the terminal device can be specific devices in embodiments of the disclosure.

It should be understood that, the terms “system” and “network” herein are usually interchangeable. The term “and/or” herein is used to describe an association relationship between associated objects and represents that three relationships may exist. For example, A and/or B may represent the following three cases: only A exists, both A and B exist, and only B exists. The character “/” herein generally indicates an “or” relationship between the associated objects.

It should be understood that, “indication” referred to in embodiments of the disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that that there is an association relationship between A and B.

In the elaboration of embodiments of the disclosure, the term “correspondence” may mean that there is a direct or indirect correspondence between the two, may mean that there is an association between the two, or may mean a relationship of indicating and indicated or configuring and configured, etc.

In order to facilitate understanding of the technical solutions of embodiments of the disclosure, the technical technologies related to embodiments of the disclosure are described below, and the following related technologies, as optional solutions, can be arbitrarily combined with the technical solutions of embodiments of the disclosure, all of which belong to the protection scope of embodiments of the disclosure.

Exemplarily, FIG. 2 illustrates a schematic diagram of a 5G network system architecture. The 5G network includes a UE and a (radio) access network ((R)AN) device, as well as a data network (DN) and the following multiple core network elements: a network slice selection function (NSSF), an authentication server function (AUSF), a unified data management (UDM), an access and mobility management function (AMF), a session management function (SMF), a policy control function (PCF), an application function (AF), and a user plane function (UPF).

The UE performs an access stratum (AS) connection, exchanges AS messages, and performs wireless data transmission with the AN through the Uu interface. The UE performs a non-access stratum (NAS) connection and exchanges NAS messages with the AMF through the N1 interface. The AMF is a mobility management function in the core network, and the SMF is a session management function in the core network. The AMF is also responsible for forwarding messages related to the session management between the UE and the SMF, in addition to performing the mobility management on the UE. The PCF is a policy management function in the core network, which is responsible for formulating policies related to the mobility management, the session management, billing and the like for the UE. The UPF is a user plane function in the core network, which performs the data transmission with the external DN through the N6 interface and performs the data transmission with the AN through the N3 interface.

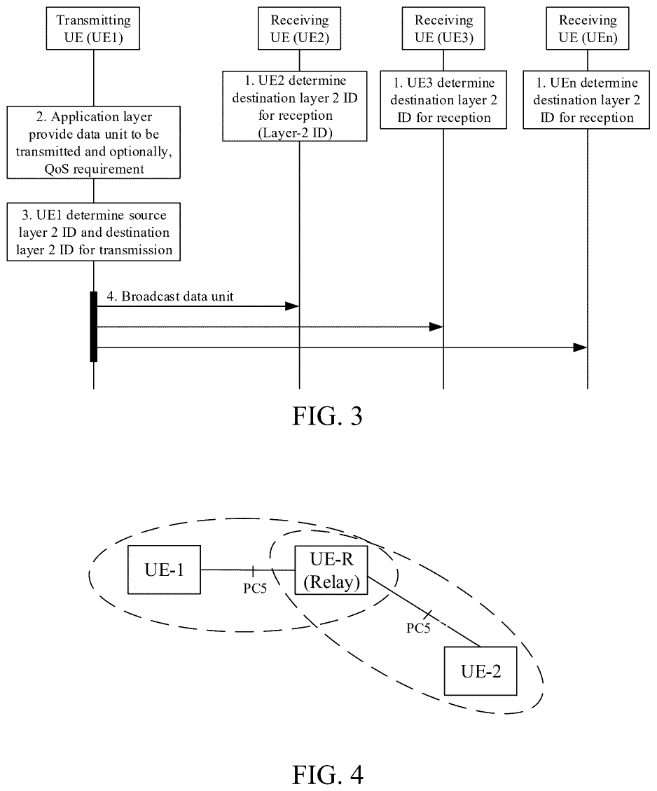

A UE with ProSe capability can broadcast a data unit through a PC5 interface, and other UEs with ProSe capability receive the broadcast through the PC5 interface. As illustrated in FIG. 3, UE1 broadcasts a data unit through a PC5 interface.

Since short-range communication in broadcast/multicast mode only supports direct communication between two UEs with ProSe capability. That is, the two UEs need to be close. If the monitoring UE is far away from the broadcast/multicast UE, the monitoring UE cannot monitor broadcast/multicast information.

In embodiments of the disclosure, a manner of forwarding broadcast/multicast through a relay UE can be considered. When two UEs with ProSe capability are far apart and cannot directly establish communication through the PC5 interface, the two UEs can use a relay UE with ProSe capability to relay the communication. As illustrated in FIG. 4, the relay UE-R can directly communicate with UE1 through a PC5 interface, and can also directly communicate with UE2 through a PC5 interface. Then, service interaction can be performed between UE1 and UE2 through the UE-R. It is necessary to consider how the relay UE determines whether received broadcast/or multicast data can be relayed.

The solutions provided in embodiments of the disclosure are mainly used to solve at least one of the above problems.

In order for more detailed understanding of features and technical contents of embodiments of the disclosure, the implementation of embodiments of the disclosure is described in detail below in conjunction with the accompanying drawings. The attached drawings are for reference only and are not intended to limit embodiments of the disclosure.

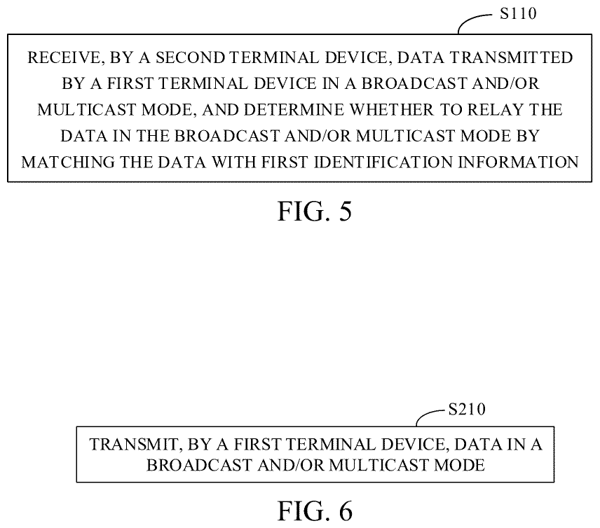

FIG. 5 is a schematic flowchart of a data transmission method according to an embodiment of the disclosure. Optionally, the method can be applied to the terminal device in the system illustrated in FIG. 1, which is not limited herein. The method includes the following.

S110. A second terminal device receives data transmitted by a first terminal device in a broadcast and/or multicast mode, and determines whether to relay the data in the broadcast and/or multicast mode by matching the data with first identification information.

For the convenience of description, in embodiments of the disclosure, data transmitted in broadcast mode may be referred to as broadcast data, and data transmitted in multicast mode may be referred to as multicast data. Accordingly, data transmitted in the broadcast and/or multicast mode may include broadcast data, or include multicast data, or include broadcast data and multicast data.

Optionally, in embodiments of the disclosure, the first identification information may be pre-acquired information for identifying data. Exemplarily, the first identification information may include an internet protocol (IP) triplet, an IP quintuple, a source link layer identifier (ID), a destination link layer ID, a service ID, filter information in Ethernet format, etc. The link layer ID is, for example, a layer 2 (L2) ID, which may also be referred to as L2 address.

Optionally, a packet header of the data may carry one or more identification information such as an IP triplet, an IP quintuple, a source L2 ID, a destination L2 ID, a service ID, etc. Specifically, the second terminal device matches the data with the first identification information as follow. The second terminal device reads the packet header of the data and matches information carried in the packet header of the data with the first identification information.

Optionally, the second terminal device may determine to relay the data in the broadcast and/or multicast mode, i.e., forward the data in the broadcast and/or multicast mode when the information carried in the packet header of the data matches the first identification information. Optionally, the second terminal device may determine not to relay the data when the information carried in the packet header of the data fails to match the first identification information.

Corresponding to the above method, another embodiment of the disclosure provides a data transmission method. Optionally, the method can be applied to the terminal device in the system illustrated in FIG. 1, which is not limited herein. The method includes the following.

S210. A first terminal device transmits data in a broadcast and/or multicast mode.

Exemplarily, the data may be used for a second terminal device receiving the data to determine whether to relay the data in the broadcast and/or multicast mode by matching the data with first identification information.

Technical details of the method can be implemented with reference to the aforementioned embodiment, which will not be repeated herein.

According to the data transmission method provided in embodiments of the disclosure, the second terminal device can determine, based on the first identification information, whether to relay the data received from the first terminal device in the broadcast and/or multicast mode, thereby realizing the relay of broadcast and/or multicast data, solving the problem that broadcast and/or multicast information cannot be monitored due to the long monitoring distance between two terminal devices, and expanding the transmission range of broadcast and/or multicast data.

In embodiments of the disclosure, the first identification information can be obtained in various manners.

In an exemplary manner, the first identification information may be information configured at the second terminal device before the broadcast and/or multicast data is received. Specifically, relay information is configured at the second terminal device, where the relay information includes the first identification information. The relay information may be understood as relay-related configuration information.

Optionally, the first identification information includes at least one of the following information: a service identifier (ID) of data allowed to be relayed, or a destination link layer ID carried by data allowed to be relayed.

Optionally, the relay information configured at the second terminal device may further include first indication information. The first indication information indicates that data transmitted in the broadcast and/or multicast mode is allowed to be relayed. For example, the first indication information is an indication of allowing broadcast and/or multicast data obtained by monitoring a specific layer 2 ID (that is, broadcast and/or multicast data whose destination layer 2 ID is the specific layer 2 ID) to be relayed, or an indication of allowing broadcast and/or multicast data of a specific service to be relayed.

Optionally, the relay information configured at the second terminal device may further implicitly include the first indication information. That is, the relay information may implicitly indicate that data transmitted in the broadcast and/or multicast mode is allowed to be relayed. For example, when the relay information includes the first identification information, the relay information may indicate that data transmitted in the broadcast and/or multicast mode is allowed to be relayed.

Optionally, the relay information is pre-configured, or configured by a first network device.

Optionally, the first network device includes a policy control network element, a short-range management network element, or an application server. The policy control network element is, for example, a PCF of a core network. The application server is, for example, an application server of a short-range service.

Exemplarily, the policy control network element or the short-range management network element may transmit the relay information to the second terminal device through a mobility management network element such as an AMF, for example, by using a UE configuration update message, a downlink NAS transparent transmission message, or other messages to carry the relay information. The application server may transmit the relay information to the second terminal device through a user plane function and an access network, for example, by using an application layer message to carry the relay information.

Optionally, the relay information further includes at least one of a source link layer ID, a destination link layer ID, or quality of service (QOS) information allocated to the second terminal device for transmitting data in the broadcast and/or multicast mode. In some embodiments, the second terminal device may relay the received broadcast and/or multicast data by using at least one of the source link layer ID, the destination link layer ID, or the QoS information allocated to the second terminal device for transmitting data in the broadcast and/or multicast mode.

Optionally, in embodiments of the disclosure, the QoS information may include a QoS parameter, such as a transmission delay requirement, a transmission range, etc.

In another exemplary manner, the first identification information may be information carried in a relay request message transmitted by the first terminal device to the second terminal device.

Specifically, before the first terminal device transmits the data in the broadcast and/or multicast mode, the data transmission method further includes the following. The first terminal device transmits a relay request message to the second terminal device, where the relay request message includes the first identification information.

Accordingly, before the second terminal device receives the data transmitted by the first terminal device in the broadcast and/or multicast mode, the data transmission method further includes the following. The second terminal device receives a relay request message transmitted by the first terminal device, where the relay request message includes the first identification information.

Optionally, the first identification information includes at least one of the following information: an internet protocol (IP) triplet of data allowed to be relayed; an IP quintuple of data allowed to be relayed; filter information in Ethernet format of data allowed to be relayed; a service ID of data allowed to be relayed; a source link layer ID carried by data allowed to be relayed; or a destination link layer ID carried by data allowed to be relayed.

Optionally, before the first terminal device transmits the data in the broadcast and/or multicast mode, the first terminal device may first discover a relay terminal, that is, first determine a terminal device within communication range that supports relaying data in the broadcast and/or multicast mode, and then transmit a relay request message to the terminal device, where the relay request message carries the first identification information. When receiving the broadcast and/or multicast data, the second terminal device that receives the first identification information can match the data with the first identification information. If the data matches the first identification information, the second terminal device can relay the data in the broadcast and/or multicast mode. Optionally, discovery of the relay terminal can be based on a relay service code.

Optionally, a first relay service code is configured at the second terminal device, and the first relay service code indicates that the second terminal device supports relaying data in the broadcast and/or multicast mode.

In an exemplary manner, the second terminal device can transmit an announcement message in the broadcast and/or multicast mode, where the announcement message carries the first relay service code, so that the first terminal device that receives the announcement message knows that the second terminal device supports relaying data in the broadcast and/or multicast mode, and transmits the relay request message to the second terminal device.

Specifically, before the first terminal device transmits the relay request message to the second terminal device, the data transmission method further includes the following. The first terminal device receives an announcement message transmitted by the second terminal device in the broadcast and/or multicast mode, where the announcement message includes a first relay service code.

Accordingly, before the second terminal device receives the relay request message transmitted by the first terminal device, the data transmission method further includes the following. The second terminal device transmits an announcement message in the broadcast and/or multicast mode, where the announcement message includes the first relay service code.

In another exemplary manner, the first terminal device can transmit a relay discovery request message in the broadcast and/or multicast mode, where the relay discovery request message carries a first relay service code, so that the second terminal device receiving the relay discovery request message and configured with the same relay service code transmits a response message to the first terminal device. As such, the first terminal device knows that the second terminal device supports relaying data in the broadcast and/or multicast mode, and transmits the relay request message to the second terminal device.

Specifically, before the first terminal device transmits the relay request message to the second terminal device, the method further includes the following. The first terminal device transmits a relay discovery request message in the broadcast and/or multicast mode, where the relay discovery request message includes a first relay service code, and the relay discovery request message is used to request the second terminal device configured with the first relay service code to transmit a first response message.

Accordingly, before the second terminal device receives the relay request message transmitted by the first terminal device, the method further includes the following. The second terminal device receives a relay discovery request message transmitted by the first terminal device in the broadcast and/or multicast mode and including the first relay service code, and transmits a first response message to the first terminal device.

Optionally, the first relay service code at the second terminal device is pre-configured, or configured by a first network device.

Optionally, the first network device includes a policy control network element, a short-range management network element, or an application server. The policy control network element is, for example, a PCF of a core network. The application server is, for example, an application server of a short-range service.

Exemplarily, the policy control network element or the short-range management network element may transmit the first relay service code to the second terminal device through a mobility management network element such as an AMF, for example, by using a UE configuration update message, a downlink NAS transparent transmission message, or other messages to carry the first relay service code. The application server may transmit the first relay service code to the second terminal device through a user plane function and an access network, for example, by using an application layer message to carry the first relay service code.

Optionally, the relay request message further includes at least one of a source link layer ID, a destination link layer ID, or QoS information allocated to the second terminal device for transmitting data in the broadcast and/or multicast mode. In some embodiments, the second terminal device may relay the received broadcast and/or multicast data by using at least one of the source link layer ID, the destination link layer ID, or the QoS information allocated to the second terminal device for transmitting data in the broadcast and/or multicast mode.

Optionally, the relay request message may further include first QoS information. The first QoS information is used for the second terminal device to determine second QoS information and/or third QoS information, where the second QoS information includes QoS information allocated to the first terminal device for transmitting data in the broadcast and/or multicast mode, and the third QoS information includes QoS information allocated to the second terminal device for transmitting data in the broadcast and/or multicast mode.

That is, the second terminal device can determine the second QoS information and the third QoS information according to the first QoS information carried in the relay request message. The second QoS information is used for the first terminal device to transmit data in the broadcast and/or multicast mode, and the third QoS information is used for the second terminal device to transmit data in the broadcast and/or multicast mode.

Optionally, after the second terminal device determines the second QoS information, the data transmission method may further include the following. The second terminal device transmits a second response message to the first terminal device, where the second response message includes the second QoS information.

Accordingly, after the first terminal device transmits the relay request message to the second terminal device, the data transmission method may further include the following. The first terminal device receives a second response message transmitted by the second terminal device, where the second response message includes the second QoS information.

Further, optionally, the first terminal device transmits the data in the broadcast and/or multicast mode as follows. The first terminal device transmits the data in the broadcast and/or multicast mode by using the second QoS information.

Optionally, the data transmission method further includes the following.

The second terminal device relays the data in the broadcast and/or multicast mode by using QoS information allocated to the second terminal device for transmitting data in the broadcast and/or multicast mode, in response to determining that the data is to be relayed in the broadcast and/or multicast mode.

Exemplarily, the QoS information allocated to the second terminal device for transmitting data in the broadcast and/or multicast mode may be the QoS information allocated to the second terminal device for transmitting data in the broadcast and/or multicast mode included in the relay information configured at the second terminal device, or the QoS information allocated to the second terminal device for transmitting data in the broadcast and/or multicast mode carried in the relay request message transmitted by the first terminal device to the second terminal device, or the third QoS information determined by the second terminal device based on the first QoS information carried in the relay request message transmitted by the first terminal device. It can be understood that, in some embodiments of the disclosure, the QoS information for transmitting data in the broadcast and/or multicast mode may be allocated to the second terminal device in other manners, which is not limited herein.

Optionally, when the data is determined to be relayed in the broadcast and/or multicast mode, the second terminal device may relay the data in the broadcast and/or multicast mode by using a link layer ID allocated to the second terminal device for transmitting data in the broadcast and/or multicast mode, or a link layer ID carried by the received data, or a link layer ID generated by the second terminal device. Specifically, the method may include any one of the following.

The second terminal device relays the data in the broadcast and/or multicast mode by using a source link layer ID and/or a destination link layer ID allocated to the second terminal device for transmitting data in the broadcast and/or multicast mode, in response to determining that the data is to be relayed in the broadcast and/or multicast mode.

The second terminal device relays the data in the broadcast and/or multicast mode by using a source link layer ID and/or a destination link layer ID carried by the data, in response to determining that the data is to be relayed in the broadcast and/or multicast mode.

The second terminal device relays the data in the broadcast and/or multicast mode by using a source link layer ID and/or a destination link layer ID generated by the second terminal device, in response to determining that the data is to be relayed in the broadcast and/or multicast mode.

The source link layer ID and/or the destination link layer ID allocated to the second terminal device for transmitting data in the broadcast and/or multicast mode may be the source link layer ID and/or the destination link layer ID in the relay information or the relay request message, or a source link layer ID and/or a destination link layer ID allocated in other manners, which is not limited herein.

With at least one of above embodiments, the second terminal device that receives the data transmitted by the first terminal device in the broadcast and/or multicast mode can determine, based on the first identification information, whether the received data can be relayed, and can further determine the link layer ID and the QoS information used in relay broadcast and/or multicast. Several specific examples are provided below for better understanding of features of embodiments of the disclosure. For ease of description and understanding, in the following examples, UE1 represents the first terminal device, and a relay UE represents the second terminal device that supports or allows relaying broadcast and/or multicast data.

### Example 1

In this example, relay-related information (hereinafter referred to as “relay information”) is configured at the relay UE. The relay information includes information authorizing relay broadcast or multicast, such as an indication of allowing relay broadcast/multicast of data belonging to a specific service, or an indication of allowing relay broadcast/multicast of data obtained by monitoring a specific layer 2 ID. The relay information may further include at least one of a source layer 2 ID, a destination layer 2 ID, or QoS information for the relay UE to transmit broadcast/multicast data.

Specifically, the configured relay information can refer to following example forms.

One form: a service ID, and/or an indication of allowing relay broadcast/multicast for the service, and/or a source L2 ID used in relay broadcast/multicast for the service, and/or a destination L2 ID used in relay broadcast/multicast for the service, and/or QoS information for transmitting broadcast/multicast data.

Another form: an L2 ID of received data (i.e., a destination L2 ID carried in the data), and/or an indication of allowing relay broadcast/multicast of data obtained by monitoring the L2 ID, and/or a source L2 ID used in relay broadcast/multicast of data obtained by monitoring the L2 ID, and/or a destination L2 ID used in relay broadcast/multicast of data obtained by monitoring the L2 ID, and/or QoS information for transmitting broadcast/multicast data.

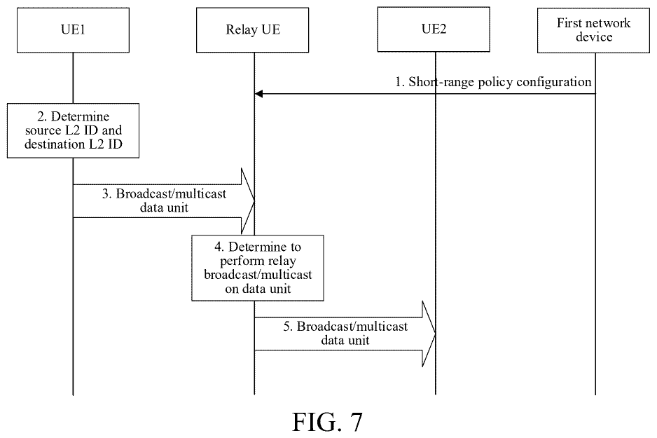

In this example, as illustrated in FIG. 7, the data transmission method includes the following.

Step 1: Relevant information for relay broadcast or multicast is configured at the relay UE, where the information can also be referred to as short-range policy configuration.

Specifically, the information can be pre-configured at the relay UE, or configured and transmitted by the first network device to the relay UE. For example, the first network device is a PCF or a short-range management network element located in the core network. The information is transmitted to the relay UE by the PCF or the short-range service management network element through an AMF. Specifically, the information can be transmitted to the relay UE by using a UE configuration update message, a downlink NAS transparent transmission message, etc. For another example, the first network device can be a short-range service application server and transmits the information to the relay UE through an application layer message.

Step 2: When UE1 needs to broadcast/multicast, a source L2 ID (hereinafter referred to as a “first source L2 ID”) is allocated for use, and a destination L2 ID (hereinafter referred to as a “first destination L2 ID”) used for broadcast/multicast is determined.

Step 3: UE1 broadcasts/multicasts a data unit by using the first source L2 ID and the first destination L2 ID. A header of the data unit carries the first source L2 ID and the first destination L2 ID, and may further carry a service ID.

Step 4: The relay UE obtains the data unit broadcast/multicast by UE1, and determines whether the relay UE needs to relay the data unit by comparing the data unit with the short-range policy configuration obtained at step 1.

For example, if a service ID for which relay broadcast/multicast is allowed is configured at step 1, and the header of the received data unit carries the service ID, relay broadcast/multicast is performed on the data unit.

For example, if it is configured at step 1 that a data unit received from the first destination L2 ID needs to be relayed, relay broadcast/multicast is performed on the data unit.

The relay UE determines a source L2 ID and a destination L2 ID used in relay broadcast/multicast. In one case, the relay UE can directly use the first source L2 ID and the first destination L2 ID received. In another case, the relay UE can use a second source L2 ID and a second destination L2 ID allocated to the relay UE for broadcasting/multicasting data, such as a source L2 ID allocated by the relay UE itself and a destination L2 ID used in relay broadcast/multicast configured at step 1. In another case, the relay UE can use a second source L2 ID and/or a second destination L2 ID generated by itself.

Step 5: The relay UE broadcasts/multicasts the data unit received at step 3 by using the source L2 ID and the destination L2 ID determined at step 4, where QoS information used in broadcast/multicast is QoS information configured at step 1.

### Example 2

A relay service code is configured at UE1 and the relay UE, where the relay service code indicates that relay broadcast/multicast is allowed. Specifically, the relay service code can be pre-configured at the UE, or can be transmitted by the first network device. For example, the first network device is a PCF or a short-range management network element located in the core network. The information is transmitted to the UE by the PCF or the short-range service management network element through an AMF. Specifically, the relay service code can be transmitted to the UE by using a UE configuration update message, a downlink NAS transparent transmission message, etc. For example, the first network device can be a short-range service application server and transmits the relay service code to the UE through an application layer message.

Before broadcasting/multicasting, if UE1 expects a relay terminal to relay broadcast/multicast data of UE1, UE1 first discovers a relay terminal.

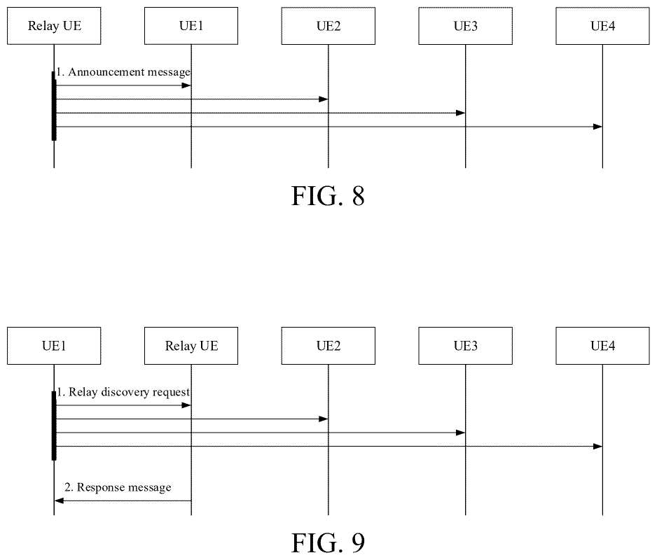

In one manner, as illustrated in FIG. 8, the relay UE broadcasts/multicasts an announcement message, where the announcement message carries the relay service code. After monitoring the announcement message, UE1 knows that the relay UE supports relay broadcast/multicast, and thus can select the relay UE for relay.

In another manner, as illustrated in FIG. 9. UE1 first broadcasts a request message (such as the aforementioned relay discovery request message), where the request message includes the relay service code. The relay UE monitors the request message and then knows that UE1 needs to request relay service, and the relay UE transmits a response message to UE1, so that UE1 can select the relay UE for relay.

After selecting the relay UE, UE1 transmits a relay request message to the relay UE. The relay request message includes identification information of data that needs relay broadcast/multicast, and may further include one or more information such as a source layer 2 ID, a destination layer 2 ID, QoS information, and the like for the relay UE to transmit broadcast/multicast data.

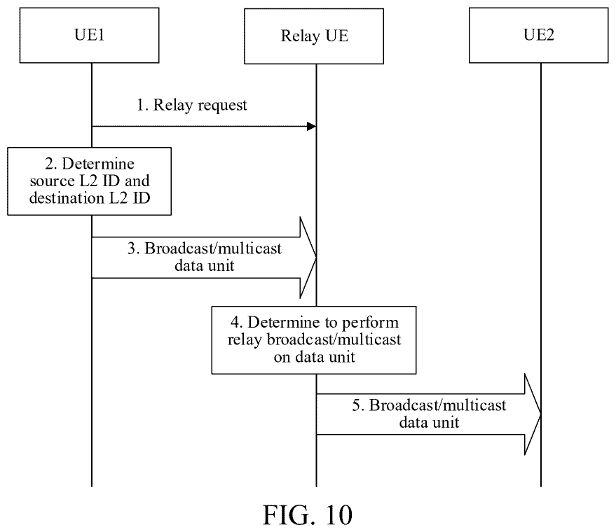

Specifically, as illustrated in FIG. 10, the data transmission method in this example includes the following.

Step 1: UE1 transmits a relay request message to the relay UE, where the relay request message includes identification information of data that needs relay broadcast/multicast. The identification information is filter information that can be used to match a data packet, such as an IP triplet, an IP quintuple, filter information in Ethernet format, a service ID, a source layer 2 ID, a destination layer 2 ID, etc. The message may further include one or more information such as a source layer 2 ID, a destination layer 2 ID, QOS information, and the like allocated to the relay UE for transmitting broadcast/multicast data.

Step 2: When UE1 needs to broadcast/multicast, a first source L2 ID is allocated for use, and a first destination L2 ID used for broadcast/multicast is determined.

It should be noted that there is no time sequence relationship between steps 1 and 2. For example, the relay request message may be transmitted first and then the L2 ID used for broadcast/multicast may be allocated, or the L2 ID used for broadcast/multicast may be allocated first and then the relay request message may be transmitted. In addition, the source layer 2 ID at step 1 may be the same as or different from the source layer 2 ID at step 2, and the destination layer 2 ID at step 1 may be the same as or different from the destination layer 2 ID at step 2.

Step 3: UE1 broadcasts/multicasts a data unit by using the first source L2 ID and the first destination L2 ID.

Step 4: The relay UE obtains the data unit broadcast/multicast by UE1, and relays the data unit by matching the data unit with the identification information of data that needs relay broadcast/multicast obtained at step 1.

The relay UE determines a source L2 ID and a destination L2 ID used in relay broadcast/multicast. In one case, the relay UE directly uses the first source L2 ID and the first destination L2 ID received. In another case, the relay UE can generate a second source L2 ID and a second destination L2 ID by itself. In another case, if the relay request message received at step 1 includes a source L2 ID and a destination L2 ID used in relay broadcast/multicast, the source L2 ID and the destination L2 ID received are used.

Step 5: The relay UE broadcasts/multicasts the data unit received at step 3 by using the source L2 ID and the destination L2 ID for relay broadcast/multicast. QoS information used in broadcast/multicast is the QoS information received at step 1.

### Example 3

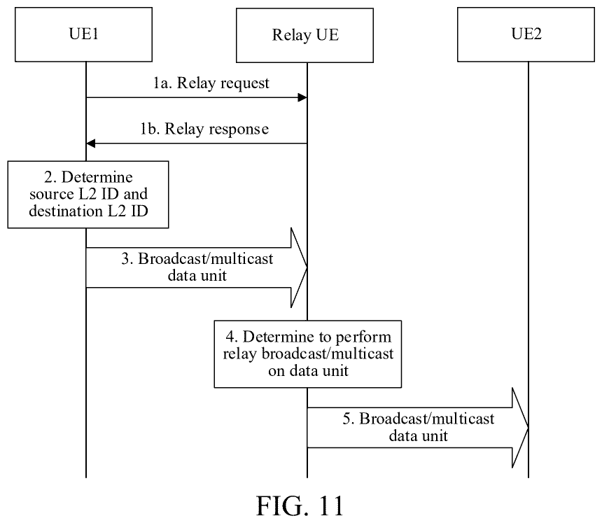

This example is different from example 2 in that after receiving a relay request message, the relay UE transmits a relay response message as illustrated at step 1b of FIG. 11.

After receiving the relay request message of step 1a, the relay UE determines second QoS information and third QoS information according to first QoS information carried in the relay request message, and transmits the second QoS information to UE1 at step 1b. QoS information used by UE1 in broadcast/multicast at step 3 is the QoS information received at step 1b. QoS information used by the relay UE in broadcast/multicast at step 5 is the third QoS information.

For example, the first QoS information carried in the relay request message transmitted at step 1a is a delay requirement of 100 milliseconds (ms). Based on the delay requirement of 100 ms, the relay UE determines that the second QoS information is a delay requirement of 30 ms and the third QoS information is a delay requirement of 70 ms. Then, the delay requirement transmitted by the relay UE to UE1 at step 1b is 30 ms. UE1 broadcasts/multicasts according to the delay requirement of 30 ms. The relay UE broadcasts/multicasts according to the delay requirement of 70 ms.

For another example, the QoS information at step 1a is a broadcast/multicast range of 100 meters (m), or a specific QoS requirement which can be met within a range of 100 m. The relay UE determines that the second QoS information is a broadcast/multicast range of 30 m, and the third QoS information is a broadcast/multicast range of 70 m. Then, the broadcast/multicast range transmitted by the relay UE to UE1 at step 1b is 30 m. UE1 broadcasts/multicasts according to the broadcast/multicast range of 30 m, or ensures that a specific QoS requirement is met within the broadcast/multicast range of 30 m. The relay UE broadcasts/multicasts according to the range requirement of 70 m.

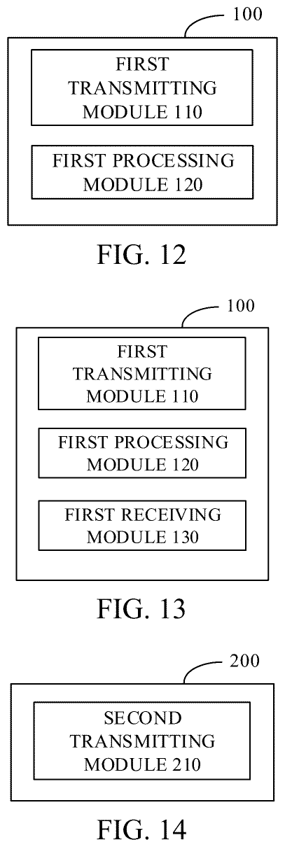

Corresponding to the data transmission method of at least one of above embodiments, embodiments of the disclosure further provides a second terminal device 100. Referring to FIG. 12, the second terminal device 100 includes a first transmitting module 110 and a first processing module 120. The first transmitting module 110 is configured to receive data transmitted by a first terminal device in a broadcast and/or multicast mode. The first processing module 120 is configured to determine whether to relay the data in the broadcast and/or multicast mode by matching the data with first identification information.

Optionally, relay information is configured at the second terminal device 100, where the relay information includes the first identification information.

Optionally, the first identification information includes at least one of the following information: a service identifier (ID) of data allowed to be relayed; or a destination link layer ID carried by data allowed to be relayed.

Optionally, the relay information is pre-configured, or configured by a first network device.

Optionally, the relay information further includes at least one of a source link layer ID, a destination link layer ID, or quality of service (QOS) information allocated to the second terminal device for transmitting data in the broadcast and/or multicast mode.

Optionally, as illustrated in FIG. 13, the second terminal device 100 may further include a first receiving module 130. The first receiving module 130 is configured to receive a relay request message transmitted by the first terminal device, where the relay request message includes the first identification information.

Optionally, the first identification information includes at least one of the following information: an internet protocol (IP) triplet of data allowed to be relayed; an IP quintuple of data allowed to be relayed; filter information in Ethernet format of data allowed to be relayed; a service ID of data allowed to be relayed; a source link layer ID carried by data allowed to be relayed; or a destination link layer ID carried by data allowed to be relayed.

Optionally, a first relay service code is configured at the second terminal device 100, and the first relay service code indicates that the second terminal device supports relaying data in the broadcast and/or multicast mode.

Optionally, the first transmitting module 110 is further configured to: transmit an announcement message in the broadcast and/or multicast mode, where the announcement message includes the first relay service code.

Optionally, the first receiving module 130 is further configured to: receive a relay discovery request message transmitted by the first terminal device in the broadcast and/or multicast mode and including the first relay service code, and transmitting a first response message to the first terminal device.

Optionally, the first relay service code is pre-configured, or configured by a first network device.

Optionally, the first network device includes a policy control network element, a short-range management network element, or an application server.

Optionally, the relay request message further includes at least one of a source link layer ID, a destination link layer ID, or QoS information allocated to the second terminal device for transmitting data in the broadcast and/or multicast mode.

Optionally, the relay request message further includes first QoS information, and the first QoS information is used for the second terminal device to determine second QoS information and/or third QoS information, where the second QoS information includes QoS information allocated to the first terminal device for transmitting data in the broadcast and/or multicast mode, and the third QoS information includes QoS information allocated to the second terminal device for transmitting data in the broadcast and/or multicast mode.

Optionally, the first transmitting module 110 is further configured to: transmit a second response message to the first terminal device, where the second response message includes the second QoS information.

Optionally, the first transmitting module 110 is further configured to: relay the data in the broadcast and/or multicast mode by using QoS information allocated to the second terminal device for transmitting data in the broadcast and/or multicast mode, in response to determining that the data is to be relayed in the broadcast and/or multicast mode.

Optionally, the first transmitting module 110 is further configured to: relay the data in the broadcast and/or multicast mode by using a source link layer ID and/or a destination link layer ID carried by the data, in response to determining that the data is to be relayed in the broadcast and/or multicast mode.

Optionally, the first transmitting module 110 is further configured to: relay the data in the broadcast and/or multicast mode by using a source link layer ID and/or a destination link layer ID allocated to the second terminal device for transmitting data in the broadcast and/or multicast mode, in response to determining that the data is to be relayed in the broadcast and/or multicast mode.

Optionally, the first transmitting module 110 is further configured to: relay the data in the broadcast and/or multicast mode by using a source link layer ID and/or a destination link layer ID generated by the second terminal device, in response to determining that the data is to be relayed in the broadcast and/or multicast mode.

The second terminal device 100 in embodiments of the disclosure can implement corresponding functions of the second terminal device in embodiments of the foregoing method. For the procedure, function, implementation, and advantage corresponding to each module (sub-module, unit, or assembly, etc.) in the second terminal device 100, reference can be made to the corresponding illustrations in the foregoing method embodiments, which will not be described in detail again herein. It should be noted that, the functions of various modules (sub-modules, units, or assemblies, etc.) in the second terminal device 100 described in embodiments of the disclosure may be implemented by different modules (sub-modules, units, or assemblies, etc.), or may be implemented by the same module (sub-module, unit, or assembly, etc.). For example, the first transmitting module and the first receiving module may be different modules or may be the same module, both of which can implement the corresponding functions thereof in embodiments of the disclosure. In addition, the communicating module in embodiments of the disclosure may be implemented by a transceiver of a device, and some or all of the other modules may be implemented by a processor of the device.

FIG. 14 is a schematic block diagram of a first terminal device 200 according to an embodiment of the disclosure. The first terminal device 200 may include a second transmitting module 210. The second transmitting module 210 is configured to transmit data in a broadcast and/or multicast mode, where the data is used for a second terminal device receiving the data to determine whether to relay the data in the broadcast and/or multicast mode by matching the data with first identification information.

Optionally, the second transmitting module 210 is further configured to: transmit a relay request message to the second terminal device, where the relay request message includes the first identification information.

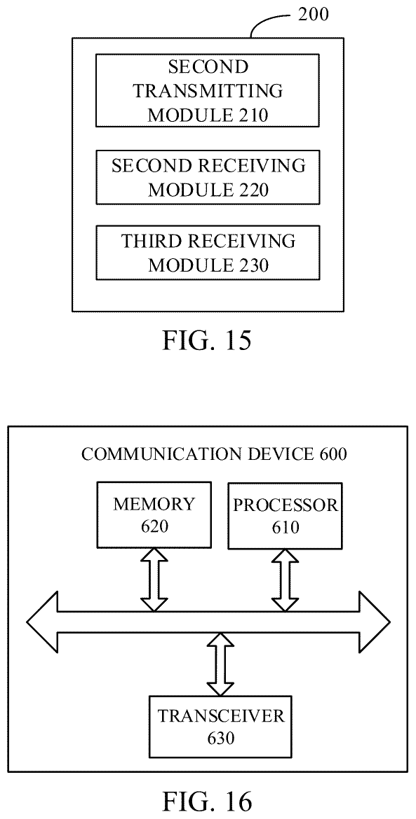

Optionally, as illustrated in FIG. 15, the first terminal device 200 further includes a second receiving module 220. The second receiving module 220 is configured to receive an announcement message transmitted by the second terminal device in the broadcast and/or multicast mode, where the announcement message includes a first relay service code, and the first relay service code indicates that the second terminal device supports relaying data in the broadcast and/or multicast mode.

Optionally, the second transmitting module 210 is further configured to: transmit a relay discovery request message in the broadcast and/or multicast mode, where the relay discovery request message includes a first relay service code, and the relay discovery request message is used to request the second terminal device configured with the first relay service code to transmit a first response message.

Optionally, the relay request message further includes at least one of a source link layer ID, a destination link layer ID, or quality of service (QOS) information allocated to the second terminal device for transmitting data in the broadcast and/or multicast mode.

Optionally, the relay request message further includes first QoS information, and the first QoS information is used for the second terminal device to determine second QoS information and/or third QoS information, where the second QoS information includes QoS information allocated to the first terminal device for transmitting data in the broadcast and/or multicast mode, and the third QOS information includes QoS information allocated to the second terminal device for transmitting data in the broadcast and/or multicast mode.

Optionally, as illustrated in FIG. 15, the first terminal device 200 further includes a third receiving module 230. The third receiving module 230 is configured to receive a second response message transmitted by the second terminal device, where the second response message includes the second QoS information.

Optionally, the second transmitting module 210 is specifically configured to: transmit the data in the broadcast and/or multicast mode by using the second QoS information.

The first terminal device 200 in embodiments of the disclosure can implement corresponding functions of the first terminal device in embodiments of the foregoing method. For the procedure, function, implementation, and advantage corresponding to each module (sub-module, unit, or assembly, etc.) in the first terminal device 200, reference can be made to the corresponding illustrations in the foregoing method embodiments, which will not be described in detail again herein. It should be noted that, the functions of various modules (sub-modules, units, or assemblies, etc.) in the first terminal device 200 described in embodiments of the disclosure may be implemented by different modules (sub-modules, units, or assemblies, etc.), or may be implemented by the same module (sub-module, unit, or assembly, etc.). For example, the second receiving module and the third receiving module may be different modules or may be the same module, both of which can implement the corresponding functions thereof in embodiments of the disclosure. In addition, the communicating module in embodiments of the disclosure may be implemented by a transceiver of a device, and some or all of the other modules may be implemented by a processor of the device.

FIG. 16 is a schematic block diagram of a communication device 600 according to embodiments of the disclosure. The communication device 600 includes a processor 610. The processor 610 may invoke and execute computer programs stored in a memory, to perform the methods in embodiments of the disclosure.

Optionally, the communication device 600 may further include a memory 620. The processor 610 may invoke and execute a computer program from the memory 620, to perform the methods in embodiments of the disclosure.

The memory 620 may be a separate device independent of the processor 610 or may be integrated in the processor 610.

Optionally, the communication device 600 may further include a transceiver 630. The processor 610 may control the transceiver 630 to communicate with other devices. Specifically, the transceiver 630 may transmit information or data to other devices or receive information or data transmitted by other devices.

The transceiver 630 may include a transmitter and a receiver. The transceiver 630 may further include antennas, the number of which may be one or more.

Optionally, the communication device 600 may be the first terminal device in embodiments of the disclosure, and the communication device 600 may implement corresponding processes implemented by the first terminal device in various methods according to embodiments of the disclosure, which will not be repeated herein.

Optionally, the communication device 600 may be the second terminal device in embodiments of the disclosure, and the communication device 600 may implement corresponding processes implemented by the second terminal device in various methods according to embodiments of the disclosure, which will not be repeated herein.

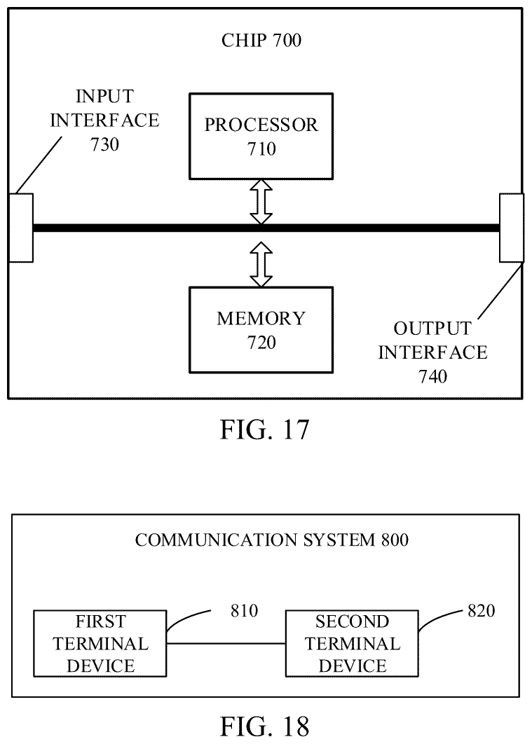

FIG. 17 is a schematic block diagram of a chip 700 according to embodiments of the disclosure. The chip 700 includes a processor 710, which may invoke and execute a computer program from a memory to perform the methods in embodiments of the disclosure.

Optionally, the chip 700 may further include a memory 720. The processor 710 may invoke and execute a computer program from the memory 720 to perform the methods in embodiments of the disclosure.

The memory 720 may be a separate device independent of the processor 710 or may be integrated in the processor 710.

Optionally, the chip 700 may further include an input interface 730. The processor 710 may control the input interface 730 to communicate with other devices or chips. Specifically, the processor 410 may acquire information or data transmitted by other devices or chips.

Optionally, the chip 700 may further include an output interface 740. The processor 710 may control the output interface 740 to communicate with other devices or chips. Specifically, the processor 410 may output information or data to other devices or chips.

Optionally, the chip may be applied to the first terminal device in embodiments of the disclosure, and the chip may implement corresponding processes implemented by the first terminal device in various methods according to embodiments of the disclosure, which will not be repeated herein.

Optionally, the chip may be applied to the second terminal device in embodiments of the disclosure, and the chip may implement corresponding processes implemented by the second terminal device in various methods according to embodiments of the disclosure, which will not be repeated herein.

It should be understood that the chip mentioned in embodiments of the disclosure may also be referred to as a system-level chip, a system chip, a chip system, or a system-on-chip, etc.

The above-mentioned processor may be a general-purpose processor, a digital signal processor (DSP), a field programmable gate array (FPGA), an application specific integrated circuit (ASIC) or another programmable logic device, a transistor logic device, a discrete hardware component, etc. The general-purpose processor mentioned above may be a microprocessor or any conventional processor.

The above-mentioned memory may be a volatile memory or a non-volatile memory, or may include both volatile and non-volatile memories. The non-volatile memory may be a read-only memory (ROM), a programmable ROM (PROM), an erasable PROM (EPROM), an electrically erasable EPROM (EEPROM), or a flash memory. The volatile memory may be a random access memory (RAM).

It should be understood that the foregoing memories are exemplary but not restrictive description. For example, the memory in embodiments of the disclosure may be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a direct rambus RAM (DR RAM), etc. That is, the memory in embodiments of the disclosure is intended to include, but is not limited to, these and any other suitable types of memories.

FIG. 18 is a schematic block diagram of a communication system 800 according to embodiments of the disclosure. The communication system 800 includes a terminal device 810 and a network device 820.

The first terminal device 810 is configured to transmit data in the broadcast and/or multicast mode.

The second terminal device 820 is configured to receive data transmitted by a first terminal device in a broadcast and/or multicast mode, and determine whether to relay the data in the broadcast and/or multicast mode by matching the data with first identification information.

The first terminal device 810 can be configured to implement corresponding functions implemented by the first terminal device in the methods of embodiments of the disclosure, and the second terminal device 820 may be configured to implement corresponding functions implemented by the second terminal device in the methods of embodiments of the disclosure, which will not be repeated herein for the sake of brevity.

The functions in embodiments described above may be implemented in whole or in part through software, hardware, firmware, or any combination thereof. When implemented through software, the functions may be implemented in whole or in part in a form of a computer program product. The computer program product includes one or more computer instructions. When the computer program instructions are loaded and executed on a computer, processes or functions are generated in whole or in part according to embodiments of the disclosure. The computer may be a general-purpose computer, a special purpose computer, a computer network, or another programmable apparatus. The computer instructions may be stored in a computer-readable storage medium, or may be transmitted from one computer-readable storage medium to another computer-readable storage medium. For example, the computer instructions may be transmitted from a website site, a computer, a server, or a data center to another website site, computer, server, or data center through a wired mode (e.g., a coaxial cable, an optical fiber, and a digital subscriber line (DSL)) or a wireless mode (e.g., infrared radiation, radio, and microwave.). The computer-readable storage medium may be any available medium which a computer may access to, or a data storage device such as a server or data center that includes one or more available media integrated therein. The available medium may be a magnetic medium (e.g., a floppy disk, a hard disk, and a magnetic tape), an optical medium (e.g., a digital video disc (DVD)), or a semiconductor medium (e.g., a solid state disk (SSD)), or the like.

It should be understood that sizes of serial numbers of the foregoing processes do not mean execution sequences in various embodiments of the disclosure. The execution sequences of the processes should be determined according to functions and internal logics of the processes, and should not impose any limitation on embodiment processes of embodiments of the disclosure.

Those skilled in the art may clearly understand that for the sake of convenience and conciseness of description, specific working processes of the systems, apparatuses, and units described above may be known with reference with corresponding processes in the aforementioned method embodiments, and will not be repeated herein.

In the description of the specification, the term such as “an embodiment”, “some embodiments”, “example”, “specific example” or “some examples” is intended to indicate that specific features, structures, materials, or characteristics related to embodiments or examples are included in at least one embodiment or example of the disclosure. Moreover, the specific features, structures, materials, or characteristics can be combined in any one or more embodiments or examples in any suitable way. In addition, technical features of above embodiments or examples may be combined arbitrarily. In order to make the description concise, not all possible combinations of technical features in above embodiments are described. However, as long as there is no contradiction in the combination of these technical features, those skilled in the art can combine and associate different embodiments or examples described in the disclosure, so as to obtain new embodiments, which should be considered to be within the scope of the disclosure.

Furthermore, terms such as “first” and “second” are only used for descriptive purposes, and are not to be understood as indicating or implying the relative importance or implicitly indicating the number of indicated technical features. Thus, features defined by “first” or “second” may explicitly or implicitly include one or more of the features. In the description of the embodiments of the present invention, term “a plurality of” or “multiple” means two or more unless otherwise specified.

What are described above are specific embodiments of the disclosure, but the protection scope of the disclosure is not limited thereto. Any variation or substitution that may easily occur to a person skilled in the art within the technical scope disclosed in the disclosure shall be included within the protection scope of embodiments of the disclosure. Therefore, the protection scope of the disclosure shall be subject to the protection scope of the claims.

1. A data transmission method, comprising:
receiving, by a second terminal device, data transmitted by a first terminal device in a broadcast and/or multicast mode; and
determining whether to relay the data in the broadcast and/or multicast mode by matching the data with first identification information.

2. The method of claim 1, wherein relay information is configured at the second terminal device, wherein the relay information comprises the first identification information.

3. The method of claim 2, wherein the first identification information comprises at least one of the following information:
a service identifier (ID) of data allowed to be relayed; or
a destination link layer ID carried by data allowed to be relayed.

4. The method of claim 2, wherein the relay information is pre-configured, or configured by a first network device.

5. The method of claim 2, wherein the relay information further comprises at least one of a source link layer ID, a destination link layer ID, or quality of service (QOS) information allocated to the second terminal device for transmitting data in the broadcast and/or multicast mode.

6. The method of claim 1, wherein before receiving, by the second terminal device, the data transmitted by the first terminal device in the broadcast and/or multicast mode, the method further comprises:
receiving, by the second terminal device, a relay request message transmitted by the first terminal device, wherein the relay request message comprises the first identification information.

7. (canceled)

8. The method of claim 6, wherein a first relay service code is configured at the second terminal device, and the first relay service code indicates that the second terminal device supports relaying data in the broadcast and/or multicast mode.

9. (canceled)

10. The method of claim 8, wherein before receiving, by the second terminal device, the relay request message transmitted by the first terminal device, the method further comprises:
receiving, by the second terminal device, a relay discovery request message transmitted by the first terminal device in the broadcast and/or multicast mode and comprising the first relay service code, and transmitting a first response message to the first terminal device.

11-12. (canceled)

13. The method of claim 6, wherein the relay request message further comprises at least one of a source link layer ID, a destination link layer ID, or QoS information allocated to the second terminal device for transmitting data in the broadcast and/or multicast mode.

14-15. (canceled)

16. The method of claim 1, further comprising:
relaying, by the second terminal device, the data in the broadcast and/or multicast mode by using QoS information allocated to the second terminal device for transmitting data in the broadcast and/or multicast mode, in response to determining that the data is to be relayed in the broadcast and/or multicast mode.

17. (canceled)

18. The method of claim 1, further comprising:
relaying, by the second terminal device, the data in the broadcast and/or multicast mode by using a source link layer ID and/or a destination link layer ID allocated to the second terminal device for transmitting data in the broadcast and/or multicast mode, in response to determining that the data is to be relayed in the broadcast and/or multicast mode.

19-54. (canceled)

55. A second terminal device comprising:
a transceiver;
a memory configured to store computer programs; and
a processor configured to invoke and execute the computer programs stored in the memory to cause the second terminal device to:
receive data transmitted by a first terminal device in a broadcast and/or multicast mode; and
determine whether to relay the data in the broadcast and/or multicast mode by matching the data with first identification information.

56. A first terminal device, comprising:
a transceiver;
a memory configured to store computer programs; and
a processor configured to invoke and execute the computer programs stored in the memory to cause the first terminal device to:
transmit data in a broadcast and/or multicast mode, wherein the data is used for a second terminal device receiving the data to determine whether to relay the data in the broadcast and/or multicast mode by matching the data with first identification information.

57-61. (canceled)

62. The second terminal device of claim 55, wherein relay information is configured at the second terminal device, wherein the relay information comprises the first identification information.

63. The second terminal device of claim 62, wherein the first identification information comprises at least one of the following information:
a service identifier (ID) of data allowed to be relayed; or
a destination link layer ID carried by data allowed to be relayed.

64. The second terminal device of claim 62, wherein the relay information is pre-configured, or configured by a first network device.

65. The second terminal device of claim 62, wherein the relay information further comprises at least one of a source link layer ID, a destination link layer ID, or quality of service (QoS) information allocated to the second terminal device for transmitting data in the broadcast and/or multicast mode.

66. The second terminal device of claim 55, wherein the processor is further configured to cause the second terminal device to:
relay the data in the broadcast and/or multicast mode by using QoS information allocated to the second terminal device for transmitting data in the broadcast and/or multicast mode, in response to determining that the data is to be relayed in the broadcast and/or multicast mode.

67. The second terminal device of claim 55, wherein the processor is further configured to cause the second terminal device to:
relay the data in the broadcast and/or multicast mode by using a source link layer ID and/or a destination link layer ID allocated to the second terminal device for transmitting data in the broadcast and/or multicast mode, in response to determining that the data is to be relayed in the broadcast and/or multicast mode.

68. The first terminal device of claim 56, wherein the processor is further configured to cause the first terminal device to:
transmit a relay request message to the second terminal device, wherein the relay request message comprises the first identification information.
